(19) United States
(12) Patent Application Publication
(10) Pub. No.: US 2009/0021526 A1
(43) Pub. Date: Jan. 22, 2009

(54) DETERMINATION METHOD FOR WHITE-POINT AND CORRECTION METHOD OF THE WHITE BALANCE

(75) Inventors: Ming-Feng Chiang, Miaoli County (TW); Yen-Hsi Lee, Taipei City (TW); Chia-Ho Lin, Hsinchu County (TW); Chih-Yuan Yang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/933,405

(22) Filed: Oct. 31, 2007

(30) Foreign Application Priority Data
Jul. 20, 2007 (TW) 96126589

(51) Int. Cl. G09G 5/02

(52) U.S. Cl. 345/605

(57) ABSTRACT

A determination method for white-point and a correction method of the white balance are disclosed. In the determination method for white-point of the white balance, first gray cards with different reflection coefficients are detected according to the properties of an image sensing device. Next, the white-point gray line of a first color temperature and the white-point gray line of a second color temperature are intersected on a white-point plane to form a fan area, so as to set the white-point range of the low saturation of the image sensing device. Next, the vertical projection for an image datum is calculated to obtain a placement datum on the white-point plane, and a difference value between the image datum and the placement datum is calculated. Finally, whether the image datum is a white-point is determined according to the difference value and relationship between the placement datum and the fan area.

### CROSS-REFERENCE TO RELATED APPLICATION

This application claims the priority benefit of Taiwan application serial no. 96126589, filed on Jul. 20, 2007. All disclosure of the Taiwan application is incorporated herein by reference.

### BACKGROUND OF THE INVENTION

1. Field of the Invention

The present invention generally relates to an adjusting method of a digital image, and more particularly, to a determination method for white-point and correction method of the white balance.

2. Description of Related Art

With the coming of the digital image age, and digital image devices, such as digital cameras or digital video cameras and so on, are becoming popular, more and more people are using the digital image devices. The digital image devices are essential for people's lives. Thus, people may usually see digital images, such as digital photographs.

When we see a digital photograph, we may find that the color of the image of the object shown in the digital photograph is different from the primary color of the object. When the object is projected under different light sources, the color of the object may vary. For example, the color of a white paper may vary when projected under the sun, a fluorescent lamp, a tungsten lamp or a star. However, our brains may detect and correct the color change, such that regardless of a nature light or an artificial source, we still see that the color of the white paper is white. In a certain color temperature range, regardless of under the sun, in the haze weather, indoors, under a fluorescent lamp, or under a tungsten lamp, we can still see that the color of the white paper is white because of our visual corrections. However, for a digital camera with a charge coupled device (CCD) which is an image sensing device, the CCD can not correct the color temperature change, and an image datum adjustment may be performed by using the white-balance device in the digital camera. That is, the color of the image of the white object may be white by using the white balance.

With respect to a color digital image, its color is composed of red (R), green (G) and blue (B) primary colors. FIG. 1 is a diagram illustrating a RGB color coordinates in case of no black-body radiation, wherein a white-point (WP) is composed of isometric R, G, and B light. Referring to FIG. 1, different colors are formed by different combinations of the red (R), green (G) and blue (B) primary colors. The white-point gray line (GL) is the line connecting the WP (1, 1, 1) and dark-point (0, 0, 0), and the GL represents the gray level.

However, when the properties of an image sensor are considered, the white-point may not be described as in FIG. 1. With respect to the same color, the response degrees of different image sensors are different. And under different light sources, such as a nature light source or an artificial light source, the same image sensor may also generate different color responses because of the color temperature change. When the color temperature of the light source is as low as 2850° K, the color tone trends to be red-yellow, and when the color temperature of the light source is high as 8500° K, the color tone trends to be blue. Because the image sensor may generate the color tone deviations, the color is distorted.

There are many different color coordinates according to the existing color tone theories, and in the existing color tone theories, the color tone is distributed by different properties. Besides the RGB color coordinates, general color coordinates may comprise CYM, CYMK, HS, HSV, YcbCr, YUV, and YIQ color coordinates and so on. And there are fixed transformation matrixes between the different color coordinates. In order to resolve the white-balance problem, in the conventional techniques, the tone analysis may be performed by using the YCbCr color coordinates, and the Y component represents brightness, and the Cb component represents blue, and the Cr component represents red. And the properties of the white-point of the YCbCr color coordinates are shown in FIG. 2. FIG. 2 is a diagram illustrating the relationship between the white-point and the color temperature change in the conventional YCbCr color coordinates. Referring to FIG. 2, the white-point may vary according to the color temperature change, such that a zigzag white-point curved surface 201 is formed from the low color temperature L1 to the high color temperature LN. With respect to white-points with the same color temperature and different brightness, the curved degree of the curved surface may also vary.

An estimation method for the white-point deviation of the white balance is provided in Taiwan Patent Application no. 091133111, which is also filed by the applicant of the present invention. However, its shortcoming is that some image points are usually not in the predetermined range of the corrected color temperature in the process of performing white balance, such that an error may be occurred.

Accordingly, in the process of performing white balance, it is necessary to determine whether an image datum is a white-point in a color-temperature range, and it is necessary to accurately estimate the properties of the image datum, and it is necessary to perform a white-balance correction to make the color of the image of the object shown in the digital photograph more like the color of the object which people can see. So, it is necessary to provide techniques to resolve the above problems.

### SUMMARY OF THE INVENTION

The present invention is directed to a determination method for the white-point of the white balance, the determination method may determine whether an image datum is a white-point in a color temperature range.

The present invention is also directed to a correction method for the white balance, wherein a plurality of ambient light value modes are set, and each of the ambient light value modes has a plurality of ambient color temperature blocks, and each of the plurality of ambient color temperature blocks corresponds to a correction reference color temperature value. When an image datum is corrected, the correction operation may be performed in an appropriate ambient light value mode, such that the color of the image of the object shown in the digital photograph may be clear to color of the object which people can see.

The present invention provides a determination method for the white-point of the white balance. The determination method for the white-point comprises: a plurality of gray cards with different reflection coefficients are detected in the range from a first color temperature to a second color temperature according to the properties of an image sensing device, such that at least a first group of color temperature data and a second group of color temperature data on a first color coordinates are obtained, wherein the second color temperature is larger than the first color temperature; a coordinate rotation operation is performed for the data detected in the range from the first color temperature to the second color temperature to obtain a white-point plane on a second color coordinates, and the error caused by projecting the color temperature data on the white-point plane is minimized; a white-point gray line of the first color temperature and a white-point gray line of the second color temperature are formed on the white-point plane after the coordinate rotation operation is performed for the first group of color temperature data and the second group of color temperature data, wherein the white-point gray line of the first color temperature and the white-point gray line of the second color temperature are intersected to form a fan area, so as to set the white-point range of the low saturation of the image sensing device, wherein the white-point gray line of the first color temperature is the line connecting a dark point and the white-point of the first color temperature, and the white-point gray line of the second color temperature is the line connecting the dark point and the white-point of the second color temperature, and the dark point is the collection of white-points at all color temperature; a plurality of image data on the first color coordinates are obtained; the same coordinate rotation operation is performed for the image datum to rotate the image datum to be on the second color coordinates to obtain a rotated image datum; the vertical projection for the rotated image datum is calculated to obtain a placement datum on the white-point plane, and a difference value between the rotated image datum and the placement datum is also calculated; and it may be determined whether the image datum is a white-point according to the difference value and the relationship between the placement datum and the fan area.

According to an embodiment of the determination method for the white-point of the white balance, the step of determining whether the image datum is a white-point according to the difference value and the relationship between the placement datum and the fan area comprises if the placement datum is in the fan area, the possibility that the image datum is a white-point may be determined according to the difference value, wherein if the difference value is smaller, the possibility that the image datum is a white-point is higher, and if the difference value is larger, the possibility that the image datum is a white-point is lower; and if the placement datum is out of the fan area, the image datum is not a white-point.

The present invention also provides a correction method of the white balance. The correction method of the white balance comprises: a plurality of gray cards with different reflection coefficients are detected in the range from a first color temperature to a second color temperature according to the properties of an image sensing device, such that at least a first group of color temperature data and a second group of color temperature data on a first color coordinates are obtained, wherein the second color temperature is larger than the first color temperature; a coordinate rotation operation is performed for the data detected in the range from the first color temperature to the second color temperature to obtain a white-point plane on a second color coordinates, and an error caused by projecting the color temperature data on the white-point plane is minimized; a white-point gray line of the first color temperature and a white-point gray line of the second color temperature are formed on the white-point plane after the coordinate rotation operation is performed for the first group of color temperature data and the second group of color temperature data, wherein the white-point gray line of the first color temperature and the white-point gray line of the second color temperature are intersected to form a fan area, so as to set the white-point range of the low saturation of the image sensing device, wherein the white-point gray line of the first color temperature is the line connecting a dark point and the white-point of the first color temperature, and the white-point gray line of the second color temperature is the line connecting the dark point and the white-point of the second color temperature, and the dark point is the collection of white-points at all color temperature; the fan area is divided into a plurality of ambient color temperature blocks, and each corresponding to a correction reference color temperature value; image data on the first color coordinates is obtained; the same coordinate rotation operation is performed for the image data to rotate the image data to be on the second color coordinates to obtain a plurality of rotated image data; the vertical projections for the rotated image data are calculated to get a plurality of placement data on the white-point plane; and the image data may be corrected according to the placement data projected in each of the ambient color temperature blocks and the correction reference color temperature value corresponds to each of the ambient color temperature blocks.

According to an embodiment of the present invention, the white-point gray line of the first color temperature and the white-point gray line of the second color temperature corresponding to an ambient light value mode may be set according to the ambient light value mode to adjust the range of the fan area.

In the present invention, a plurality of gray cards with different reflection coefficients are detected in the range from a first color temperature to a second color temperature according to the properties of an image sensing device, and a coordinate rotation operation is performed for the data obtained in the -range from the first color temperature to the second color temperature to get a white-point plane on a second color coordinates, and the error caused by projecting the color temperature data on the white-point plane is minimized. Furthermore, in the determination method for the white-point, a fan area is formed on the white-point plane, and the vertical projection for an image datum is calculated to get a placement datum on the white-point plane, and a difference value between the rotated image datum and the placement datum is also calculated, and it may be determined whether the image datum is a white-point according to the difference value and the relationship between the placement datum and the fan area. In the correction method for the ambient color temperature of the white balance, an fan area is formed on the white-point plane, and the fan area is divided into a plurality of ambient color temperature blocks, and each of the plurality of ambient color temperature blocks corresponds to a correction reference color temperature value; image data on the first color coordinates is obtained; the same coordinate rotation operation is performed for the image data to rotate the image data to be on the second color coordinates to obtain a plurality of rotated image data; the vertical projections for the rotated image data are calculated to get a plurality of placement data on the white-point plane, and the image data may be corrected according to the placement datum of each of the ambient color temperature blocks and the correction reference color temperature value corresponding to each of the ambient color temperature blocks, such that the CCD may imitate the visual correction functions of people. Accordingly, in the present invention, the adjustment for the white balance may be implemented in the digital image devices.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating RGB color coordinates.

FIG. 2 is a diagram illustrating relationship between the white-point and the color temperature change in an YcbCr color coordinates.

FIG. 3 is a flowchart illustrating a determination method for white-point according to an embodiment of the present invention.

FIG. 4 is a diagram illustrating relationship between rotated YIQ image data and white-point plane.

FIG. 5 is a diagram illustrating relationship between an ambient light value and a fan area according to another embodiment of the present invention.

FIG. 6 is a flowchart illustrating a correction method of a white balance according tb another embodiment of the present invention.

FIG. 7 is a diagram illustrating a table for an ambient color temperature blocks and corresponding correction reference color temperature values.

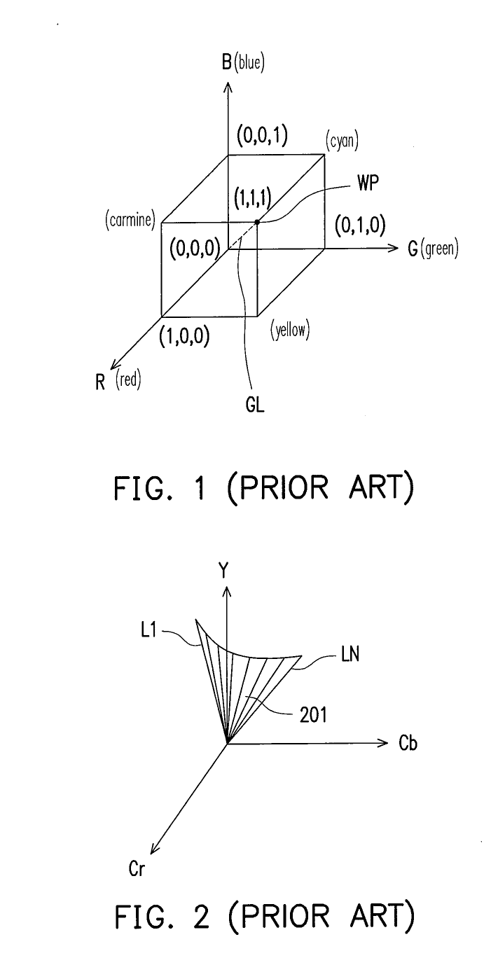

### DESCRIPTION OF THE EMBODIMENTS

The present invention is directed to a determination method for the white-point and correction method of the white balance, and the error caused by the color temperature change may be decreased.

The white balance is important for the color, and the conventional techniques can not accurately determine whether an image datum is a white-point, and can not correct the color tone according to the ambient color temperature change. Accordingly, in the conventional techniques, an error or a false determination may be generated because of the color temperature change.

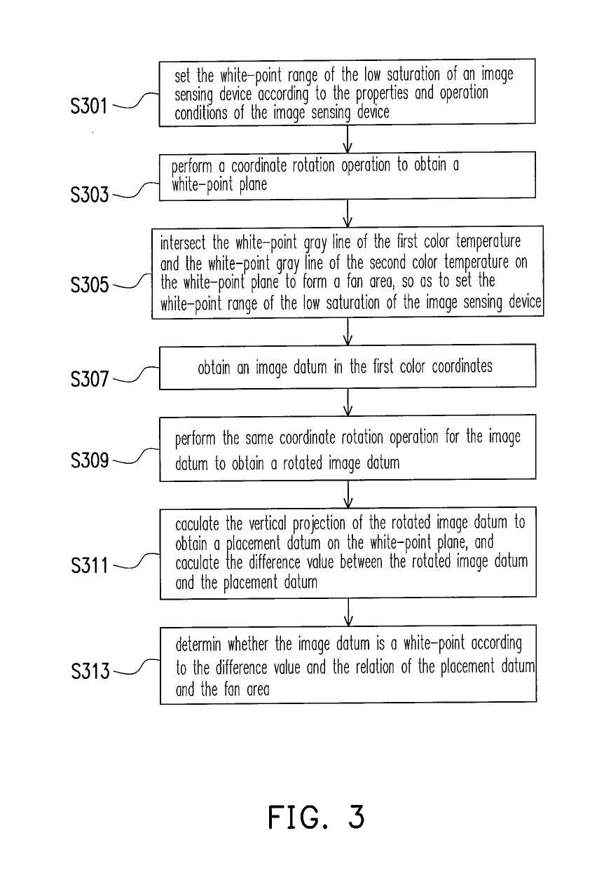

In order to accurately determine whether an image datum is a white-point, the present determination method for the white-point is provided. FIG. 3 is a flowchart illustrating the determination method for the white-point according to an embodiment of the present invention. Referring to FIG. 3, at step of S301, the white-point range of the low saturation of an image sensing device may be set according to the properties and operation conditions of the image sensing device. And a plurality of gray cards with different reflection coefficients are detected in the range from a first color temperature to a second color temperature according to the properties of the image sensing device, and at least a first group of color temperature data and a second group of color temperature data are obtained in a first color coordinates, wherein the second color temperature is larger than the first color temperature. And a lens is an essential element for the image sensing device, and the lens may effect the measurement (detection). And the image sensing device may further comprise a charge coupled device (CCD). The sensing device may measure the gray cards with different reflection coefficients to obtain the data, and the measure method is not limited to a certain method. In the present embodiment, according to the properties of the image sensing device, 6 gray cards with different reflection coefficients may be detected in the range from 3000° K to 7500° K, for example, a group of color temperature data are measured at each of 3000° K., 4000° K, 5000° K, 6500° K and 7500° K, and each group of color temperature data comprises 6 measurement data on the RGB color coordinates, such that at least 30 image data about the gray cards may be obtained, wherein the six image data measured at 3000° K is represented as the first group of color temperature data, and the six image data measured at 7500° K is represented as the second group of color temperature data. It is understood by those of ordinary skill that the first color coordinates is not limited to the RGB color coordinates.

At step of S303, a coordinate rotation operation is performed for the data detected in the range from the first color temperature to the second color temperature to obtain a white-point plane on a second color coordinates, such that the error caused by projecting the color data on the white-point plane is minimized. For example, in the range from 3000° K to 7500° K, the color temperature data of each of the gray cards with different coefficients are measured, and the properties of the color temperature data are analysed by using a mathematical method, such that the three basises of the second color coordinates may be obtained by a coordinates transformation method and an optimization theory (for example, a minimization error method), and the white-point plane may be obtained on the second color coordinates. However, the coordinates rotation operation formula is not limited to a certain mathematical formula, and the coordinates rotation operation formula may vary with the designs.

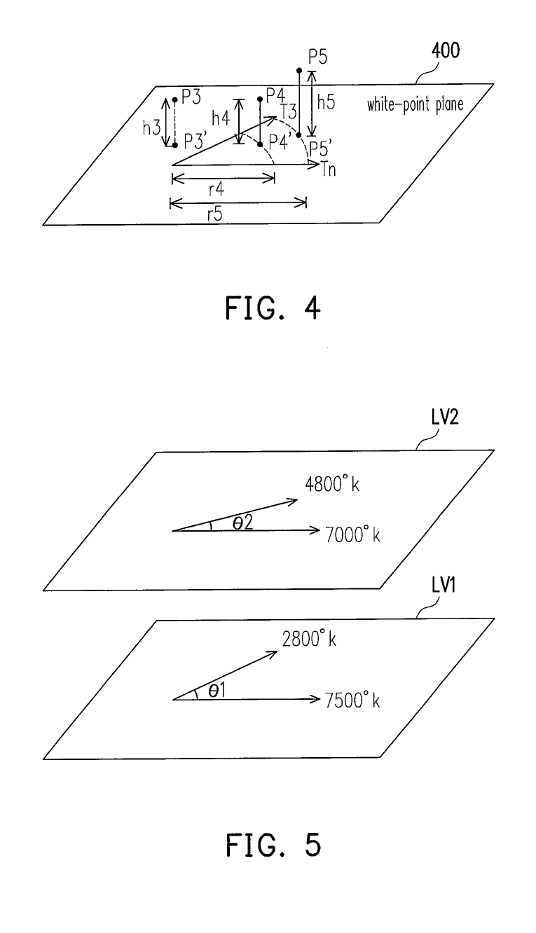

Then a white-point gray line may be defined as a line connecting a white-point and a dark-point at a color temperature, and the white-point gray line may represent the gray level, and the dark-point is the collection of the white-points at all the color temperature. In the step of S305, a coordinates rotation operation is performed for the first group of color temperature data and the second group of color temperature data to form the white-point gray line of the first color temperature and the white-point gray line of the second color temperature on the white-point plane, and the two white-point gray lines are intersected by an included angle to form a fan area, and the fan area may be used to set the white-point range of the low saturation of the image sensing device. For example, as shown in FIG. 4, the white-point range of the low saturation may be set from T3 to Tn, and the white-point gray line of the first color temperature T3 and the white-point gray line of the second color temperature Tn are intersected by a fan included angle on the white-point plane 400 to form a fan area, and the white-point range of the low saturation is in the fan area. It is noted that the white-point plane 400 comprises the fan area (the color temperature is from T3 to Tn). That is, a coordinate transformation operation is performed for the measurement data measured in the range from the first color temperature T3 to the second color temperature Tn in the step of S301 to form a fan distribution in the fan area of the white-point plane 400, and the transformed first group of color temperature data and the transformed second group of color temperature data are the two boundary lines of the fan area.

Returning to the step of S307 in FIG. 3, an image datum may be obtained in the first color coordinates, and the image datum may be a color-point datum or a white-point datum, and because a calculation is not performed for the image datum at the time, we may not determine whether the datum is a white-point or not. Next, in the step of S309, in order to easily analyse the image datum and determine whether the image datum is a white-point or not, a coordinate rotation operation may be performed for the image datum as in the step of S303 to obtain a rotated image datum.

Next, in the step of S3 11, the vertical projection of the rotated image datum is calculated to obtain a placement datum on the white-point plane 400, and the difference value between the rotated image datum and the placement datum. FIG. 4 is a diagram illustrating the relation between the rotated YIQ image data and the white-point plane. Referring to FIG. 4, in the present embodiment, the white-point plane 400 is illustrated as a quadrangle in order to simply describe the present invention, and in fact, the white-point plane 400 may comprise a large range of color temperature. In FIG. 4, there are several rotated image data, such as P3, P4 and P5, and the corresponding placement data are respectively P3′, P4′ and P5′, and the difference values between the rotated image data and the placement data are respectively h3, h4 and h5.

Returning to the Step of S313 in FIG. 3, it may be determined whether the image datum is a white-point according to the difference value and the relationship of the placement datum and the fan area. Referring to FIG. 4, as described above, the white-point gray line of the first color temperature T3 and the white-point gray line of the second color temperature Tn are intersected on the white-point plane to form the fan area. It may be determined whether each of the placement data is in the fan area by a mathematical equation, and the present invention is not limited thereto. Wherein, because the placement datum P3′ is not in the fan area, the corresponding image datum is not a white-point. And the placement data P4′ and P5′ are in the fan area, then it may be determined whether the corresponding image data are white-points according to the difference values h4 and h5, wherein if the difference value h4 is smaller than the difference value h5, the probability that the image datum corresponding to the difference value h4 is a white-point is higher, that is, if the difference value is smaller, the probability that the corresponding image datum is a white-point is higher. It is noted that if the difference value is zero, the corresponding image datum is a white-point.

As described above, it may be determined whether the image datum is a white-point. Furthermore, the gray level of the image datum may also be determined. Referring to FIG. 4, if the placement datum is in the fan area, the semi-diameter distance of the placement datum and the fan included angle in the fan area may be calculated, that is, the distance value of the top-point (dark point) of the fan included angle and the placement datum may be calculated. The gray level may be determined according to the distance value, if the distance is smaller, the light value of the image datum is lower, and if the distance is larger, the light value of the image datum is higher. In FIG. 4, the semi-diameter distance of the placement datum P4′ is r4, and the semi-diameter distance of the placement datum P5′ is r5, wherein r4<r5, so the brightness of image datum corresponding to the placement datum p5′ is higher. In the white balance of a display device, a correction mode according to the semi-diameter distance may be set in the method of estimating gray level, and a weighted value may be set in the correction mode, so as to correct the gray level. For example, the weighted values of the low light value whose distance value is very small and the high light value whose distance value is very large are all zero, and the weighted values of the light values whose distance values are in the range from small distance value to the large distance may be larger.

The color of the image of the object may vary under different ambient light sources, such as under stars, under candle, indoors, outdoors, in haze weather or in the sun. That is, because the color temperature changes of different ambient light sources may change the color of the object, a color deviation may be formed. For different ambient light sources, a plurality of ambient light value (LV) modes may be set, and the white-point gray line of the first color temperature and the white-point gray line of the second color temperature may be set according to each of the plurality of ambient light value (LV) modes to adjust the range of the fan area, and next, it may be determined whether the image datum is a white-point in the white balance. Thus, in the embodiment of the determination methods for white-point as shown in FIG. 3, a plurality of ambient light value (LV) modes may also be set, and the white-point gray line of the first color temperature and the white-point gray line of the second color temperature may also be set according to each of the plurality of ambient light value (LV) modes.

FIG. 5 is a diagram illustrating the relationship between the ambient light value and the fan area according to another embodiment of the present invention. In the embodiment, a plurality of ambient light value modes may be set. Referring to FIG. 5, an ambient light value mode LV1 may be set, wherein the ambient is an indoor ambient, and may comprise a large color temperature range, it may be assumed that the color temperature range is from 2800° K to 7500° K (a fan included angle θ1 ), and the first color temperature of the LV1 is 2800° K, and the second color temperature of the LV1 is 7500° K. And an ambient light value mode LV2 may be set, wherein the ambient is an outdoor ambient, and may comprise a small color temperature range, it may be assumed that the color temperature range is from 4800° K to 7000° K (a fan included angle θ2, and θ2<θ1), and the first color temperature of the LV2 is 4800° K, and the second color temperature of the LV2 is 7000° K. In the present embodiment, the ambient light values may be determined before the ambient light value modes are set, and an appropriate color temperature range may be determined according to different ambient light values. Furthermore, an appropriate ambient light value mode may be selected to show an existing color or desired color. And the method for setting the ambient light value mode is not limited thereto, and the ambient may be divided into several different ambient light value modes, such that the color temperature range may be set according to each of the several ambient light value modes. It will be understood by those of ordinary skill that various changes in form and details may be made therein without departing from the spirit and scope of the present invention as defined by the following claims.

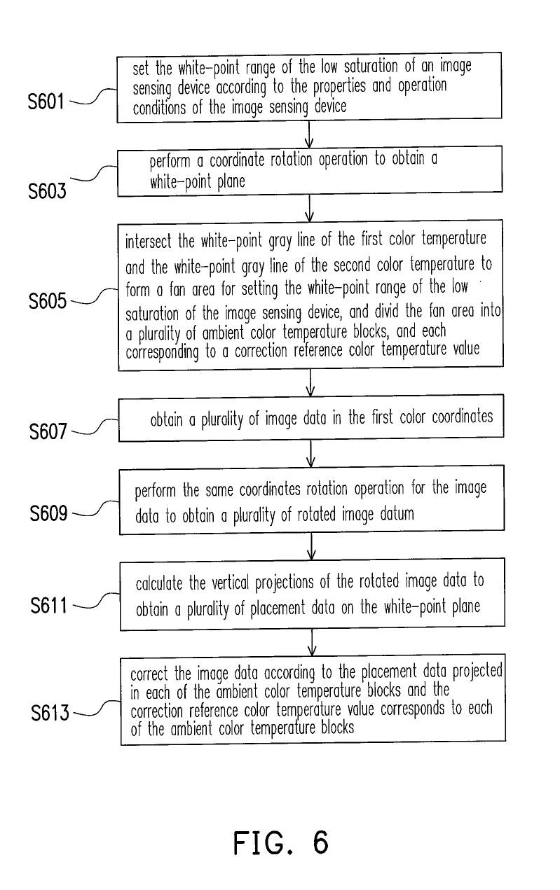

FIG. 6 is a flowchart illustrating the correction method of the white balance according to another embodiment of the present invention. Referring to FIG. 6, in the present embodiment, the image data may be corrected according to the ambient color temperature, and the detailed description for the steps of the correction method same as the determination method for white-point will be omitted. The correction method of the ambient color temperature of the white balance comprises: first, at step S601 (same as S301), the white-point range of the low saturation may be set according to the properties and operation conditions of the image sensing device. Next, at step S603 (same as S303), a coordinate rotation operation may be performed for the data measured in the range from the first color temperature to the second color temperature to obtain a white-point plane on the second color coordinates, such that the error caused by projecting the color temperature data on the white-point plane may be minimized; and next, at step S605, the white-point gray line of the first color temperature and the white-point gray line of the second color temperature are intersected to form a fan area for setting the white-point range of the low saturation of the image sensing device, and the fan area may be divided into a plurality of ambient color temperature blocks, and each of the plurality of ambient color temperature blocks corresponds to a correction reference color temperature value; and next, at step S607, a plurality of YIQ image data shown in the first color coordinates.

Next, at step S609, a coordinates rotation operation is performed for the plurality of image data, which is same as the step of S603, to obtain a plurality of rotated image data. Next, in the step of S611, the vertical projections of the plurality of rotated image data may be calculated to obtain a plurality of placement data. Next, at step S613, the image data may be corrected according to the placement data of the ambient color temperature blocks and correction reference color temperature values of the color temperature blocks.

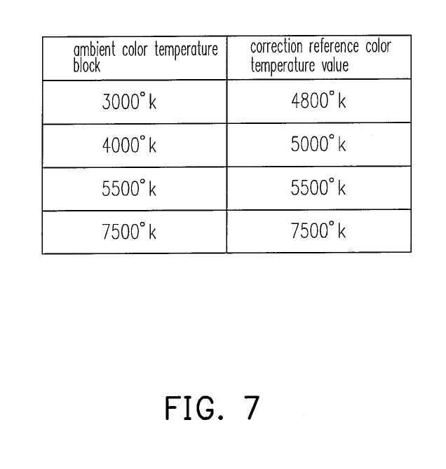

At step S613, the correction reference color temperature values may be looked up in a table. As shown in the table in FIG. 7, if the ambient color temperature block is 3000° K, the corresponding correction reference color temperature value is 4800° K; and if the ambient color temperature block is 4000° K, the corresponding correction reference color temperature value is 50000° K; and if the ambient color temperature block is 5500° K, the corresponding correction reference color temperature value is 5500° K; and if the ambient color temperature block is 7500° K, the corresponding correction reference color temperature value is 7500° K. Furthermore, if the corresponding correction reference color temperature value is not in the table, the corresponding value may be obtained by an interpolation method, an expolation method and so on. In the present invention, the number of the ambient color temperature blocks is not limited as such, and the correction reference color temperature values are also not limited to the values shown in FIG. 7, and it will be understood by those of ordinary skill that various changes in form and details may be made therein without departing from the spirit and scope of the present invention.

Furthermore, in the correction method of the white balance, a plurality of ambient light value modes may also be set, and the white-point gray line of the first color temperature and the white-point gray line of the second color temperature are set according to the ambient light value modes to adjust the range of the fan area, such that an appropriate range of the color temperature may be obtained. For example, under the sun, in the haze weather, indoors, under a fluorescent lamp, or under a tungsten lamp and so on, there are the corresponding color temperature ranges. And the fan area may be divided into a plurality of ambient color temperature blocks corresponding to the ambient light value modes, and each of the plurality of ambient color temperature blocks corresponds to correction reference color temperature value, such that the image device may imitate people's visual correction functions, or the image device may correct the color temperature to be an appropriate value.

In summary, in the determination method for the white-point, a fan area is formed on the white-point plane, and the vertical projection for an image datum is calculated to get a placement datum on the white-point plane, and a difference value between the rotated image datum and the placement datum is also calculated, and it may be determined whether the image datum is a white-point, and the gray level of the image datum may be also determined according to the relation between the placement datum and the fan area and the difference value. Furthermore, it is necessary that a plurality of ambient light value modes may also be set according to different ambient light source, and the white-point gray line of the first color temperature and the white-point gray line of the second color temperature are set according to the ambient light value modes to adjust the range of the fan area, such that an appropriate range of the color temperature may be obtained. In the correction method for the ambient color temperature of the white balance, a fan area is formed on the white-point plane, and the fan area is divided into a plurality of ambient color temperature blocks, and each of the plurality of ambient color temperature blocks corresponds to a correction reference color temperature value; an image datum on the first color coordinates is obtained; the same coordinates rotation operation is performed for the image data to rotate the image data to be on the second color coordinates to obtain a plurality of rotated image data; the vertical projections for the rotated image data are calculated to get a plurality of placement data on the white-point plane, and the image data may be corrected according to the placement datum of each of the ambient color temperature blocks and the correction reference value corresponding to each of the ambient color temperature blocks, such that the CCD may imitate the visual correction functions of people. Accordingly, in the present invention, the adjustment for the white balance may be implemented in the digital image devices. Thereby, with respect to the determination method for the white-point and the correction method of the white balance, the advantages are describe as follows:

1. the white-point range of the low saturation may be set to avoid the false determination;

2. the vertical projection on the white-point plane corresponding to an image datum may be calculated to obtain a placement datum, and it is determined whether the image datum is a white-point according to the relation of the placement datum and the fan area;

3. the gray level of the image datum may also be determined according to the semi-diameter distance between the placement datum and the fan include angle;

4. when the determination for the white-point or the correction of the white balance is performed, a plurality of color temperature ranges may be set according to the color temperature of different ambient light values, such that the size of the fan area may be adjusted; and

5. when correcting the color temperature of the white balance, each of the plurality of ambient color temperature blocks corresponds to a correction reference color temperature value, such that the image datum may be corrected to avoid the

What is claimed is:

1. A determination method for white-point of the white balance, comprising:
detecting a plurality of gray cards with different reflection coefficients in a range from a first color temperature to a second color temperature according to properties of an image sensing device such that at least a first group of color temperature data and a second group of color temperature data on a first color coordinates are obtained, wherein the second color temperature is larger than the first color temperature;
performing a coordinate rotation operation for data detected in the range from the first color temperature to the second color temperature to obtain a white-point plane on a second color coordinates, and an error caused by projecting the color temperature data on the white-point plane is minimized;
forming a white-point gray line of the first color temperature and a white-point gray line of the second color temperature on the white-point plane after the coordinate rotation operation is performed for the first group of color temperature data and the second group of color temperature data, wherein the white-point gray line of the first color temperature and the white-point gray line of the second color temperature are intersected to form a fan area, so as to set the white-point range of the low saturation of the image sensing device, wherein the white-point gray line of the first color temperature is a line connecting a dark point and the white-point of the first color temperature, and the white-point gray line of the second color temperature is a line connecting the dark point and the white-point of the second color temperature, and the dark point is a collection of white-points at all color temperature;
obtaining an image datum on the first color coordinates;
performing the coordinate rotation operation for the image datum to rotate the distortion of the image, and the color of the image of the object may be clear to the color of the object which people can see, or the color temperature may be corrected to be an appropriate value.
It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents. image datum to be on the second color coordinates to obtain a rotated image datum;
calculating a vertical projection for the rotated image datum to obtain a placement datum on the white-point plane, and calculating a difference value between the rotated image datum and the placement datum; and
determining whether the image datum is a white-point according to the difference value and relationship between the placement datum and the fan area.

2. The determination method for white-point of the white balance according to claim 1, wherein the image device comprises a lens and an image sensor.

3. The determination method for white-point of the white balance according to claim 1, wherein the plurality of gray cards with different reflection coefficients are detected at a third color temperature according to the properties of the image sensing device to obtain a third group of color temperature data, and the coordinate rotation operation is performed for the third group of color temperature data to obtain the white-point plane on the second color coordinates.

4. The determination method for white-point of the white balance according to claim 3, wherein if the third color temperature is greater than the first color temperature and the third color temperature is smaller than the second color temperature, the projections of the rotated third group of color temperature data are in the fan area.

5. The determination method for white-point of the white balance according to claim 1, wherein the step of determining whether the image datum is a white-point according to the difference value and the relation between the placement datum and the fan area comprises:
if the placement datum is in the fan area, determining whether the image datum is a white-point according to the difference value, wherein if the difference value is smaller, the probability of image datum of being a white-point is high and if the difference value is larger, the probability of image datum of being a white-point is low; and if the placement datum is out of the fan area, the image datum is not a white-point.

6. The determination method for white-point of the white balance according to claim 1, further comprising a step of determining the gray level of the image datum comprising:
calculating a distance value of the dark point and the placement datum; and
determining the gray level of the image datum according to the distance value, wherein if the distance value is smaller, a light value of the image datum is lower, and if the distance value is larger, the light value of the image datum is higher.

7. The determination method for white-point of the white balance according to claim 1, further comprising a step of setting the white-point gray line of the first color temperature and the white-point gray line of the second color temperature corresponding to an ambient light value mode to adjust a range of the fan area according to the ambient light value mode.

8. A correction method of the white balance, comprising:
detecting a plurality of gray cards with different reflection coefficients in a range from a first color temperature to a second color temperature according to properties of an image sensing device such that at least a first group of color temperature data and a second group of color temperature data on a first color coordinates are obtained, wherein the second color temperature is larger than the first color temperature;
performing a coordinate rotation operation on the data detected in the range from the first color temperature to the second color temperature to obtain a white-point plane on a second color coordinates, and an error caused by projecting the color temperature data on the white-point plane is minimized;
forming a white-point gray line of the first color temperature and a white-point gray line of the second color temperature on the white-point plane after the coordinate rotation operation is performed for the first group of color temperature data and the second group of color temperature data, wherein the white-point gray line of the first color temperature and the white-point gray line of the second color temperature are intersected to form a fan area, so as to set the white-point range of the low saturation of the image sensing device, wherein the white-point gray line of the first color temperature is a line connecting a dark point and the white-point of the first color temperature, and the white-point gray line of the second color temperature is a line connecting the dark point and the white-point of the second color temperature, and the dark point is a collection of white-points at all color temperature;
dividing the fan area into a plurality of ambient color temperature blocks, and each corresponding to a correction reference color temperature value;
obtaining a plurality of image data on the first color coordinates;
performing the coordinate rotation operation for the image data to rotate the image data to be on the second color coordinates to obtain a plurality of rotated image data;
calculating vertical projections for the rotated image data to obtain a plurality of placement data on the white-point plane; and
correcting the image data according to the placement data projected in each of the ambient color temperature blocks and the correction reference color temperature value corresponds to each of the ambient color temperature blocks.

9. The correction method of the white balance according to claim 8, wherein the image device comprises a lens and an image sensor.

10. The correction method of the white balance according to claim 8, wherein the plurality of gray cards with different reflection coefficients are detected at a third color temperature according to the properties of the image sensing device to obtain a third group of color temperature data, and the coordinate rotation operation is performed for the third group of color temperature data to obtain the white-point plane on the second color coordinates.

11. The correction method of the white balance according to claim 10, wherein if the third color temperature is greater than the first color temperature and the third color temperature is smaller than the second color temperature, the projections of the rotated third group of color temperature data are in the fan area.

12. The correction method of the white balance according to claim 8, further comprising setting the white-point gray line of the first color temperature and the white-point gray line of the second color temperature corresponding to an ambient light value mode to adjust a range of the fan area according to the ambient light value mode.

13. The correction method of the white balance according to claim 8, wherein the correction reference color temperature values corresponding to the ambient color temperature blocks are looked up on a table.
